(19) United States
(12) Patent Application Publication
(10) Pub. No.: US 2018/0005564 A1
(43) Pub. Date: Jan. 4, 2018

(54) CONTROL DEVICE FOR GATE DRIVING CIRCUIT, DISPLAY PANEL AND DISPLAY DEVICE

(71) Applicants: BOE TECHNOLOGY GROUP CO., LTD., Beijing (CN); BEIJING BOE DISPLAY TECHNOLOGY CO., LTD, Beijing (CN)

(72) Inventors: Yu XIE, Beijing (CN); Yichiang LAI, Beijing (CN); Weibiao GENG, Beijing (CN); Dongqi LIU, Beijing (CN); Zhihan ZHOU, Beijing (CN); Guangquan HE, Beijing (CN)

(21) Appl. No.: 15/521,594

(22) PCT Filed: Oct. 24, 2016
(86) PCT No.: PCT/CN2016/103474

§ 371 Date: Apr. 24, 2017

(30) Foreign Application Priority Data
Jan. 4, 2016 (CN) 201610004272.8

(51) Int. Cl. G09G 3/20

(52) U.S. Cl. CPC G09G 3/2092; G09G 2330/08; G09G 2310/08; G09G 2300/08; G09G 2310/0267; G09G 2310/0289

(57) ABSTRACT

The embodiments of the application disclose a control device for a gate driving circuit, a display panel and a display device. The control device for a gate driving circuit provided in the embodiment comprises a level shifter and a control module electrically connected with an output of the level shifter. The control module is used for controlling an output signal of the level shifter to be a low level signal when each input clock signal for the level shifter is low.

### RELATED APPLICATIONS

The present application claims the benefit of priority from the patent application No. 201610004272.8 filed on Jan. 4, 2016, the disclosure of which is incorporated herein by reference.

### FIELD OF THE INVENTION

The present application relates to the field of display technologies, and in particular to a control device for a gate driving circuit, a display panel comprising the control device and a display device comprising the display panel.

### BACKGROUND

In the field of display technology, a gate driving circuit is a circuit for providing driving signals to pixel switches in a pixel circuit. As shown in FIG. 1, a gate driving circuit usually comprises a plurality of cascaded gate driving units (for example, gate driving units 1, 2, 3), which can provide driving signals to pixel units of different rows. In order to generate the driving signals corresponding to the pixel units of different rows, the gate driving circuit typically requires clock signals as control signals. For example, FIG. 1 schematically shows that two clock signals CLK1 and CLK2 are provided to the gate driving circuit. The clock signals (e.g., CLK1 and CLK2) provided to the gate driving circuit can be generated by a level shifter.

However, the existing level shifter for a gate driving circuit has no output error protection function, so it may output an improper clock signal in some occasions, and as a result, the gate driving circuit will output an erroneous driving signal.

### SUMMARY

Embodiments of the disclosure provide a control device for a gate driving circuit, a display panel and a display device, for providing an output error protection function for the gate driving circuit.

The control device for a gate driving circuit according to the embodiments of the present invention comprises a level shifter and a control module electrically connected with an output of the level shifter. The control module is used for controlling an output signal of the level shifter to be a low level signal when each input clock signal for the level shifter is low.

With the control device provided in the embodiments of the invention, when the input clock signals for the level shifter are all low level signals, the signal outputted by the level shifter can be controlled to be a low level, which avoids the problem that the output signal is not a low level signal when the input clock signals for the level shifter are all pulled low, and provides an output error protection function for the level shifter.

In some embodiments, the control module comprises a logic unit and a switching element electrically connected with an output of the logic unit, the switching element being electrically connected with a low level reference signal, the logic unit being further electrically connected with each input clock signal for the level shifter. The logic unit is used for controlling the switching element to be switched on when each input clock signal for the level shifter is low, such that the low level reference signal is provided to the output of the level shifter.

In some embodiments, the switching element is an N-type field effect transistor, and the output of the logic unit is connected to the gate of the N-type field effect transistor, a first terminal of the N-type field effect transistor being connected with the low level reference signal and a second terminal of the N-type field effect transistor being connected with the output of the level shifter.

In some embodiments, the switching element is a P-type field effect transistor, and the output of the logic unit is connected to the gate of the P-type field effect transistor, a first terminal of the P-type field effect transistor being connected with the low level reference signal and a second terminal of the P-type field effect transistor being connected with the output of the level shifter.

In some embodiments, the logic unit comprises three OR gates and one NOT gate. The level shifter receives four input clock signals. A first input clock signal and a second input clock signal for the level shifter are inputted into a first OR gate, a third input clock signal and a fourth input clock signal for the level shifter are inputted into a second OR gate, output signals of the first OR gate and the second OR gate are inputted into a third OR gate respectively, an output signal of the third OR gate is inputted into the NOT gate, and an output signal of the NOT gate serves as an output signal of the logic unit.

In some embodiments, the control module comprises a timing controller and a switching element connected with an output of the timing controller, the switching element being electrically connected with the low level reference signal, the timing controller being further electrically connected with each input clock signal for the level shifter. The timing controller is used for controlling the switching element to be switched on when each input clock signal for the level shifter is low, such that the low level reference signal is provided to the output of the level shifter.

In some embodiments, the output of the timing controller is connected to a control terminal of the switching element, a first terminal of the switching element being connected with the low level reference signal, a second terminal of the switching element being connected with the output of the level shifter.

In some embodiments, the switching element is an N-type field effect transistor, and the level shifter receives a first input clock signal, a second input clock signal, a third input clock signal, and a fourth input clock signal, the timing controller is used for outputting a high level signal when each input clock signal for the level shifter is low, such that the N-type field effect transistor is switched on.

In some embodiments, the switching element is a P-type field effect transistor, and the level shifter receives a first input clock signal, a second input clock signal, a third input clock signal, and a fourth input clock signal, the timing controller is used for outputting a low level signal when each input clock signal for the level shifter is low, such that the P-type field effect transistor is switched on.

In another embodiment of the present invention, a display panel is provided, comprising the control device according to any one of the above embodiments.

In yet another embodiment of the present invention, a display device is provided. The display device can comprise the display panel according to the above embodiment.

### BRIEF DESCRIPTION OF DRAWINGS

FIG. 1 schematically shows a structural diagram of a gate driving circuit.

FIG. 2 shows a schematic view of a level shifter for a gate driving circuit.

FIG. 3 schematically shows a possible timing diagram of input signals and output clock signals for an existing level shifter.

FIG. 4 schematically shows a structural diagram of a control device for a gate driving circuit according to an embodiment of the invention.

FIG. 5 schematically shows a structural diagram of a level shifter and a control module in the control device according to an embodiment of the invention.

FIG. 6 schematically shows a structural diagram of a level shifter and a control module in the control device according to an embodiment of the invention.

FIG. 7 schematically shows a structural diagram of a logic unit in a control device according to an embodiment of the invention.

FIG. 8 schematically shows a structural diagram of a level shifter and a control module in a control device according to another embodiment of the invention.

FIG. 9 is a schematic view showing the timing of the output signal of a timing controller and input clock signals for a level shifter in the control device according to an embodiment of the invention.

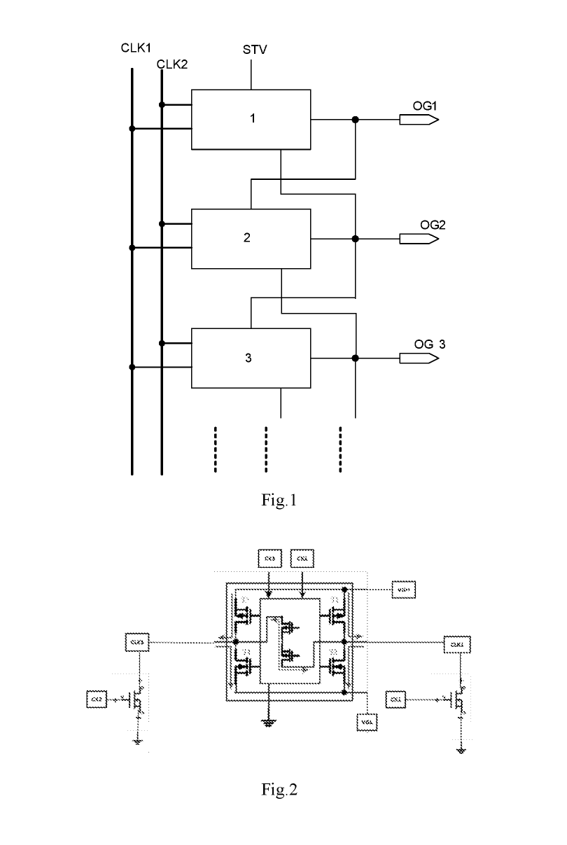

### DETAILED DESCRIPTION OF EMBODIMENTS

The embodiments of the disclosure will be described below by way of specific examples. It can be understood that, the illustrated examples are only part of the embodiments of the invention, instead of all of them. Based on principles disclosed in the embodiments described below, a person having an ordinary skill in the art can make proper modifications or variations to the described embodiments, thereby obtaining different embodiments. These all fall within the scopes of claims of the application.

The term “electrically connected” herein refers to forming a path electrically, and includes both direct connection and indirect connection. The terms “first terminal” and “second terminal” herein refer to two terminals of a switching element except for a control terminal, and moreover, the “first terminal” and the “second terminal” herein can be exchanged as they are not distinguished from each other. For example, for a field effect transistor, the first terminal can refer to either of the source and the drain, and the second terminal refers to the other of the source and the drain.

FIG. 2 shows a schematic view of a level shifter for a gate driving circuit. In actual applications, the level shifter can be in the form of an integrated circuit having a function of amplifying a voltage level. In the example as shown in FIG. 2, the level shifter can receive two input signals CK1 and CK3, and can provide two output clock signals CLK1 and CLK3. The two output clock signals CLK1 and CLK3 can be provided to the gate driving circuit as a control signal.

In the example of FIG. 2, a peripheral circuit of the level shifter further comprises switching elements (for example, field effect transistors) electrically connected with the output clock signals CLK1 and CLK3 respectively, and control terminals of the two switching elements may be controlled by control signals CX1 and CX2 respectively. For instance, when the display device comprising this level shifter is deactivated, the two switching elements can be switched on respectively under the control of the control signals CX1 and CX2, such that the output clock signals CLK1 and CLK3 are connected with a reference ground, and thereby providing of effective control signals for the gate driving circuit is ceased.

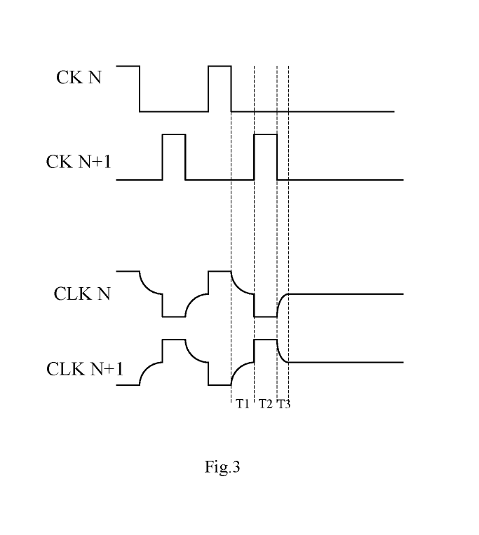

FIG. 3 schematically shows a possible timing diagram of input signals and output clock signals for the existing level shifter. Referring to FIG. 2 and FIG. 3, the level shifter can be controlled such that when the input signals CK N and CK N+1 are both low (e.g., in time period T1 as shown in FIG. 3), two output clocks signals CLK N and CLK N+1 with opposite levels are electrically connected with each other, and thereby a signal with an intermediate level is obtained. In this way, an electricity-saving effect can be achieved. Subsequently, in time period T2, one of the input signals CK N and CK N+1 becomes high, and the level shifter can output a normal clock signal. However, upon termination of signals of a frame, for example, in time period T3 as shown in FIG. 3, the output clock signals CLK N and CLK N+1 will always be electrically connected with each other because the input signals CK N and CK N+1 will not become high at this time. Therefore, the output clock signals CLK N and CLK N+1 may remain at an intermediate level until a next frame starts, thus the level shifter will not provide correct control signals to the gate driving circuit.

As shown in FIG. 3, in other words, when the input signals for the level shifter are all low, the output clock signals of the level shifter will not become low level signals based on the input signals, which may cause the gate driving circuit to output improper driving signals and switch on pixel units erroneously.

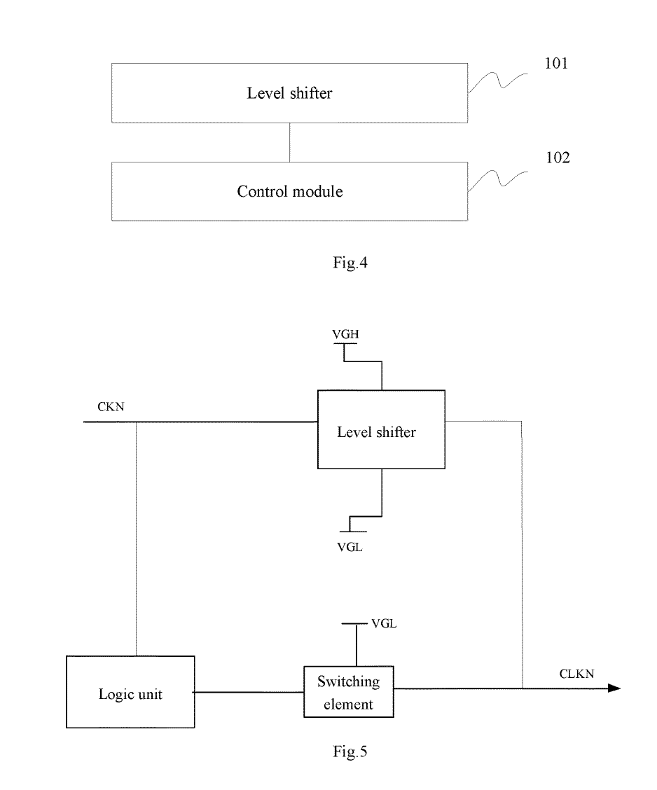

FIG. 4 schematically shows a control device for a gate driving circuit according to an embodiments of the invention, comprising a level shifter 101 and a control module 102. The control module 102 is electrically connected with an output of the level shifter 101. The control module 102 is used for controlling an output signal of the level shifter 101 to be a low level signal when each input clock signal of the level shifter 101 is low.

As discussed above, in this embodiment, the level shifter 101 can provide the gate driving circuit with one or more clock signals as control signals, and the level shifter 101 may receive one or more input clock signals. Although FIG. 2 and FIG. 3 show two input clock signals, a level shifter requiring more input clock signals can be designed upon actual needs of the gate driving circuit.

For the embodiment as shown in FIG. 4, by designing a control module connected with the output of the level shifter, the signal outputted by the level shifter can be controlled to be a low level signal when each input clock signal for the level shifter is low, which may provide an output error protection function for the level shifter, alleviates or avoids the possibility of erroneous driving signals outputted by the gate driving circuit and thus prevents the pixel units from being switched on erroneously.

In the embodiments of the disclosure, by arranging a logic unit or a timing controller at the periphery of the level shifter, the output clock signal of the level shifter can be pulled low to prevent abnormal output of the level shifter when each input clock signal for the level shifter is low. Apparently, an applicable control module is not limited to the logic unit or the timing controller illustrated in some embodiments.

According to an embodiment of the invention, as shown in FIG. 5, the control module can comprise a logic unit and a switching element electrically connected with an output of the logic unit, the switching element being electrically connected with a low level reference signal VGL. The logic unit may be further electrically connected with each input clock signals CKN for the level shifter, and the logic unit is used for controlling the switching element to be switched on when each input clock signal CKN for the level shifter is low, such that the low level reference signal VGL is provided to the output of the level shifter.

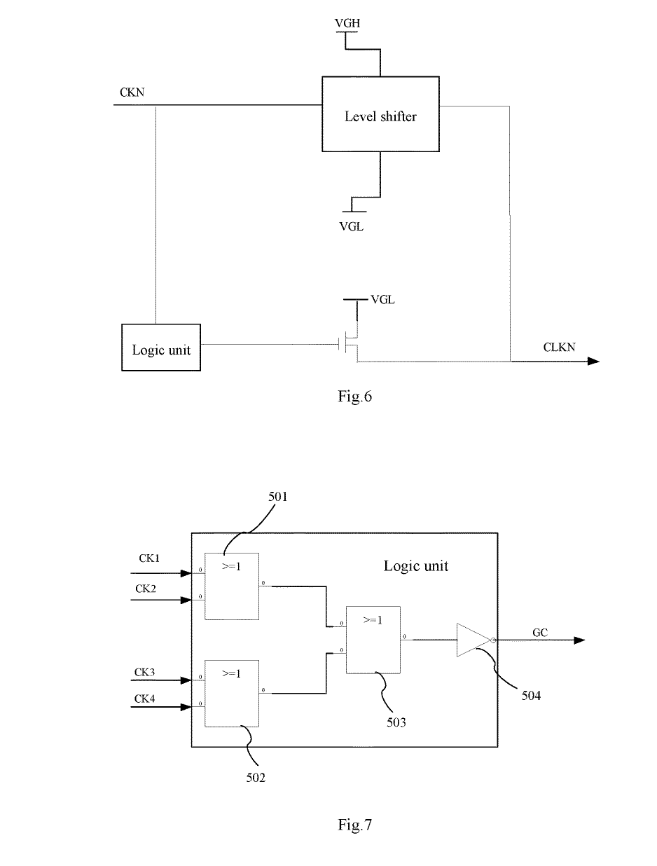

In some embodiments, as shown in FIG. 6, the switching element can be an N-type field effect transistor, and the output of the logic unit is connected to the gate of the N-type field effect transistor, a first terminal of the N-type field effect transistor being connected with the low level reference signal VGL and a second terminal of the N-type field effect transistor being connected with the output of the level shifter.

Therefore, in this embodiment, the logic unit may be designed to output a high level signal when the input clock signals to the level shifter are all low level signals such that the N-type field effect transistor is switched on, and as a result, the signal outputted by the level shifter is a low level signal at this time.

It can be understood that although FIG. 6 shows that the switching element comprises only one N-type field effect transistor, the switching element may also comprise more than one field effect transistors or other types of switches, as long as an electrical connection between the low level reference signal VGL and the output of the level shifter can be achieved by means of this switching element under the control of the output signal from the logic unit.

Alternatively, the switching element may be a P-type field effect transistor, and the output of the logic unit is connected to the gate of the P-type field effect transistor, a first terminal of the P-type field effect transistor being connected with the low level reference signal VGL and a second terminal of the P-type field effect transistor being connected with the output of the level shifter.

In this case, the logic unit may be designed to output a low level signal when the input clock signals to the level shifter are all low, such that the P-type field effect transistor is switched on.

FIG. 7 schematically shows a structure of a logic unit in a control device according to an embodiment of the invention. As shown in FIG. 7, the logic unit may comprise three OR gates and one NOT gate. A first input clock signal CK1 and a second input clock signal CK2 for the level shifter are inputted into a first OR gate 501. A third input clock signal CK3 and a fourth input clock signal CK4 for the level shifter are inputted into a second OR gate 502. Output signals of the first OR gate 501 and the second OR gate 502 are inputted into a third OR gate 503 respectively. An output signal of the third OR gate 503 is inputted into the NOT gate 504. An output signal GC of the NOT gate 504 serves as an output signal of the logic unit. That is, the embodiment as shown in FIG. 7 corresponds to a level shifter capable of receiving four input clock signals. In this embodiment, if and only if the four input clock signals CK1˜CK4 are all low, the signal GC outputted by the logic unit is high. As can be seen from FIG. 7, if the four input clock signals CK1˜CK4 are not all low, GC will be low, and the N-type field effect transistor controlled by the logic unit will not be switched on, and accordingly the level shifter will normally provide the output clock signal CLK N.

As shown in FIG. 6, when the logic unit outputs a high level, the N-type field effect transistor will be switched on such that the output clock signal CLK N of the level shifter is electrically connected to the low level reference signal VGL. Consequently, the outputs of the level shifter will be all pulled low, which prevents the gate driving circuit from outputting erroneous driving signals.

In case of a P-type field effect transistor serving as the switching element, the NOT gate 504 can be removed from the logic unit as shown in FIG. 7, thereby to obtain a control module suitable for controlling a P-type field effect transistor.

It should be noted that the structures of the logic unit described above are only exemplary, and the control module can also be a logic unit with other structures. Moreover, the signals inputted into the logic unit are not limited to the four input clock signals CK1˜CK4, but instead they can be any other numbers of input clock signals.

According to another embodiment of the invention, the control module can comprise a timing controller and a switching element connected with an output of the timing controller, the switching element being electrically connected with the low level reference signal, the timing controller being further electrically connected with each input clock signal to the level shifter. The timing controller is used for controlling the switching element to be switched on when each input clock signal to the level shifter is low, such that the low level reference signal is provided to the output of the level shifter.

As shown in FIG. 8, in an embodiment, the output of the timing controller can be connected to a control terminal of the switching element, and a first terminal of the switching element is connected with the low level reference signal VGL, and a second terminal of the switching element is connected with the output CLK N of the level shifter.

In some embodiments, the switching element is an N-type field effect transistor (e.g., as shown in FIG. 8), and the level shifter receives the first input clock signal, the second input clock signal, the third input clock signal, and the fourth input clock signal, and the timing controller is used for outputting a high level signal when each input clock signal for the level shifter is low, such that the N-type field effect transistor is switched on.

Alternatively, in other embodiments, the switching element can be a P-type field effect transistor, and the level shifter receives the first input clock signal, the second input clock signal, the third input clock signal, and the fourth input clock signal. The timing controller is used for outputting a low level signal when each input clock signal to the level shifter is low, such that the P-type field effect transistor is switched on.

The timing controller in the embodiments can be a programmable integrated circuit chip such as a Single Chip Microcomputer (SCM), and input signal pins of the chip can be electrically connected to the input clock signals for the level shifter, and output pins thereof can be electrically connected to the control terminal of the switching element. The timing controller can be programmed to output a corresponding control signal for switching on the switching element when each input clock signal for the level shifter is low, such that the low level reference signal is provided to the output of the level shifter via the switching element.

The internal structure of the timing controller is not specifically defined herein, as long as a program internally arranged enables the timing controller to output a control signal for switching on the switching element connected with the output of the timing controller when the input clock signals received are all low.

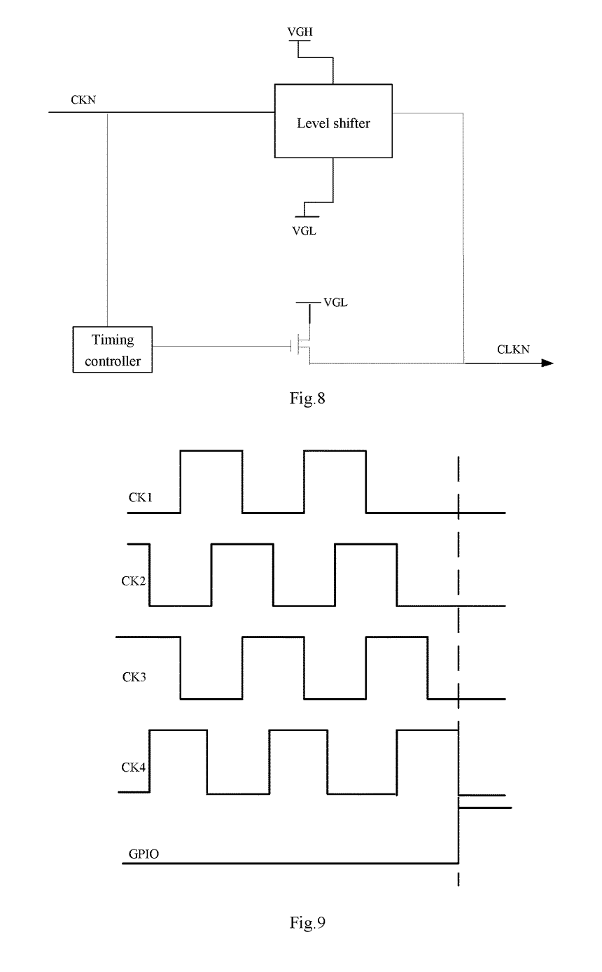

Referring to FIG. 9, for example, when a gate driving unit in the gate driving circuit needs to be reset, the clock signals (e.g., CK1˜CK4) for the level shifter are all low, an output signal GPIO of the timing controller is high such that the N-type field effect transistor is switched on, and accordingly the low level reference signal is provided to the output of the level shifter via the N-type field effect transistor.

In another embodiment of the invention, a display panel is provided, which may comprise the control device according to any of the above embodiments.

In yet another embodiment of the invention, a display device is provided, which may comprise the display panel according to the above embodiment of the invention. The display device comprises but is not limited to a device having a display function, such as a display, a mobile phone, a tablet computer, a music player, a navigator and the like.

To sum up, the embodiments of the application provide a control device for a gate driving circuit, comprising a level shifter and a control module electrically connected with an output of the level shifter. The control module is used for controlling an output signal of the level shifter to be a low level signal when each input clock signal for the level shifter is low, which provides an output error protection function for the level shifter.

A person having an ordinary skill in the art should understand that the embodiments of the application can be implemented as a method, a device or a computer program product. Therefore, these embodiments can be implemented as complete hardware embodiments, complete software embodiments, or a combination thereof. Furthermore, the embodiments of the application can be in the form of a computer program product implemented on one or more computer-readable storage mediums (including but not limited to a magnetic storage device and an optical storage device) comprising computer-readable program codes.

The present disclosure is described with reference to flow diagrams and/or block diagrams of the method, the device (system) and the computer pogrom product according to the embodiments of the present application. It should be understood that each flow and/or block of the flow diagrams and/or the block diagrams and a combination thereof can be implemented by computer program instructions. These computer program instructions can be provided to a general-purpose computer, a dedicated computer, an embedded processor or a processor of other programmable data processing devices so as to produce a machine such that the instructions executed by the computer or the processor of other programmable data processing devices produce a means for implementing functions specified in one or more flows of a flow diagram and/or in one or more blocks of a block diagram.

These computer program instructions may also be stored in a computer-readable memory capable of directing a computer or other programmable data processing devices to operate in a particular manner, such that the instructions stored in the computer-readable memory produce an article of manufacture including an instruction means for implementing functions specified in one or more flows of a flow diagram and/or in one or more blocks of a block diagram.

The computer program instructions may also be loaded onto a computer or other programmable data processing devices to cause a series of operational steps to be performed on the computer or other programmable devices to produce a computer-implemented process such that the instructions executed on the computer or other programmable devices provide steps for implementing functions specified in one or more flows of a flow diagram and/or in one or more blocks of a block diagram.

Obviously, the person having an ordinary skill in the art can make various modifications and variations to this disclosure without deviating from spirits and scopes of the invention. Thus if these modifications and variations to the present disclosure pertain to the scope of the claims of the invention and equivalent technologies thereof, the present invention also intends to encompass these modifications and variations.

1. A control device for a gate driving circuit, comprising:
a level shifter; and
a control module electrically connected with an output of the level shifter,
wherein the control module is used for controlling an output signal of the level shifter to be a low level signal when each input clock signal for the level shifter is low.

2. The control device according to claim 1, wherein the control module comprises a logic unit and a switching element electrically connected with an output of the logic unit, the switching element being electrically connected with a low level reference signal, the logic unit being further electrically connected with each input clock signal for the level shifter,
wherein the logic unit is used for controlling the switching element to be switched on when each input clock signal for the level shifter is low, such that the low level reference signal is provided to the output of the level shifter.

3. The control device according to claim 2, wherein the switching element is an N-type field effect transistor, and the output of the logic unit is connected to a gate of the N-type field effect transistor, a first terminal of the N-type field effect transistor being connected with the low level reference signal and a second terminal of the N-type field effect transistor being connected with the output of the level shifter.

4. The control device according to claim 2, wherein the switching element is a P-type field effect transistor, and the output of the logic unit is connected to a gate of the P-type field effect transistor, a first terminal of the P-type field effect transistor being connected with the low level reference signal and a second terminal of the P-type field effect transistor being connected with the output of the level shifter.

5. The control device according to claim 3, wherein the logic unit comprises three OR gates and one NOT gate, and the level shifter receives four input clock signals,
wherein a first input clock signal and a second input clock signal for the level shifter are inputted into a first OR gate, a third input clock signal and a fourth input clock signal for the level shifter are inputted into a second OR gate, output signals of the first OR gate and the second OR gate are inputted into a third OR gate respectively, an output signal of the third OR gate is inputted into the NOT gate, and an output signal of the NOT gate serves as an output signal of the logic unit.

6. The control device according to claim 1, wherein the control module comprises a timing controller and a switching element connected with an output of the timing controller, the switching element being electrically connected with a low level reference signal, the timing controller being further electrically connected with each input clock signal for the level shifter,
wherein the timing controller is used for controlling the switching element to be switched on when each input clock signal for the level shifter is low, such that the low level reference signal is provided to the output of the level shifter.

7. The control device according to claim 6, wherein the output of the timing controller is connected to a control terminal of the switching element, a first terminal of the switching element being connected with the low level reference signal, a second terminal of the switching element being connected with the output of the level shifter.

8. The control device according to claim 7, wherein the switching element is an N-type field effect transistor, and the level shifter receives a first input clock signal, a second input clock signal, a third input clock signal, and a fourth input clock signal,
wherein the timing controller is used for outputting a high level signal when each input clock signal for the level shifter is low, such that the N-type field effect transistor is switched on.

9. The control device according to claim 7, wherein the switching element is a P-type field effect transistor, and the level shifter receives a first input clock signal, a second input clock signal, a third input clock signal, and a fourth input clock signal,
wherein the timing controller is used for outputting a low level signal when each input clock signal of the level shifter is low, such that the P-type field effect transistor is switched on.

10. A display panel comprising the control device according to claim 1.

11. A display device comprising the display panel according to claim 10.

12. The display panel according to claim 10, wherein the control module comprises a logic unit and a switching element electrically connected with an output of the logic unit, the switching element being electrically connected with a low level reference signal, the logic unit being further electrically connected with each input clock signal for the level shifter,
wherein the logic unit is used for controlling the switching element to be switched on when each input clock signal for the level shifter is low, such that the low level reference signal is provided to the output of the level shifter.

13. The display panel according to claim 12, wherein the switching element is an N-type field effect transistor, and the output of the logic unit is connected to a gate of the N-type field effect transistor, a first terminal of the N-type field effect transistor being connected with the low level reference signal and a second terminal of the N-type field effect transistor being connected with the output of the level shifter.

14. The display panel according to claim 12, wherein the switching element is a P-type field effect transistor, and the output of the logic unit is connected to a gate of the P-type field effect transistor, a first terminal of the P-type field effect transistor being connected with the low level reference signal and a second terminal of the P-type field effect transistor being connected with the output of the level shifter.

15. The display panel according to claim 13, wherein the logic unit comprises three OR gates and one NOT gate, and the level shifter receives four input clock signals,
wherein a first input clock signal and a second input clock signal for the level shifter are inputted into a first OR gate, a third input clock signal and a fourth input clock signal for the level shifter are inputted into a second OR gate, output signals of the first OR gate and the second OR gate are inputted into a third OR gate respectively, an output signal of the third OR gate is inputted into the NOT gate, and an output signal of the NOT gate serves as an output signal of the logic unit.

16. The display panel according to claim 10, wherein the control module comprises a timing controller and a switching element connected with an output of the timing controller, the switching element being electrically connected with a low level reference signal, the timing controller being further electrically connected with each input clock signal for the level shifter,
wherein the timing controller is used for controlling the switching element to be switched on when each input clock signal for the level shifter is low, such that the low level reference signal is provided to the output of the level shifter.

17. The display panel according to claim 16, wherein the output of the timing controller is connected to a control terminal of the switching element, a first terminal of the switching element being connected with the low level reference signal, a second terminal of the switching element being connected with the output of the level shifter.

18. The display panel according to claim 17, wherein the switching element is an N-type field effect transistor, and the level shifter receives a first input clock signal, a second input clock signal, a third input clock signal, and a fourth input clock signal,
wherein the timing controller is used for outputting a high level signal when each input clock signal for the level shifter is low, such that the N-type field effect transistor is switched on.

19. The display panel according to claim 17, wherein the switching element is a P-type field effect transistor, and the level shifter receives a first input clock signal, a second input clock signal, a third input clock signal, and a fourth input clock signal,
wherein the timing controller is used for outputting a low level signal when each input clock signal of the level shifter is low, such that the P-type field effect transistor is switched on.
